(19) United States
(12) Patent Application Publication
(10) Pub. No.: US 2026/0180191 A1
(43) Pub. Date: Jun. 25, 2026

(54) WIDE BAND ANTENNA FEED CHAIN DEVICE

(71) Applicant: MacDonald, Dettwiler and Associates Corporation, Sainte-Anne-de-Bellevue (CA)

(72) Inventors: Karim Glâtre, Montreal (CA); Guillaume Lamontagne, Saint-Eustache (CA); Benoit Colson, Sainte-Anne-de-Bellevue (CA)

(21) Appl. No.: 18/714,469

(22) PCT Filed: Dec. 13, 2023
(86) PCT No.: PCT/CA2023/051652

§ 371 Date: May 29, 2024

Related U.S. Application Data
(60) Provisional application No. 63/432,225, filed on Dec. 13, 2022.

(51) Int. Cl. H01Q 13/02; H01Q 5/30

(52) U.S. Cl. CPC H01Q 13/0208; H01Q 5/30

(57) ABSTRACT

An antenna feed chain is provided. The antenna feed chain includes a central radiating component for transmitting or receiving signals of a first RF band and a plurality of peripheral radiating components, positioned around the central horn, for transmitting and/or receiving signals of at least a second RF band. The antenna feed chain also includes a cup, positioned around the plurality of peripheral radiating components, for improving directivity of the transmission and/or reception of the second RF band.

### TECHNICAL FIELD

The following relates generally to antennas, and more particularly to devices for wide band antenna feed chains.

### INTRODUCTION

Antenna systems may be used to transmit and receive radio frequency (RF) signals. Some antenna designs may transmit or receive RF signals across a variety of bands.

Various designs are currently implemented to enable a variety of bands, across a broad portion of the RF spectrum to be transmitted using a single antenna system. Current solutions are complex, of limited performance, provide for relatively narrow ranges of transmission and reception bands, or may not provide for sufficient wide band performance while co-locating transmission and reception of the supported RF bands, impacting antenna steering application viability.

Accordingly, there is a need for an improved antenna feed chain that overcomes at least some of the disadvantages of existing solutions.

### SUMMARY

An antenna feed chain is provided. The feed chain includes a central radiating component for transmitting or receiving signals of a first RF band and a plurality of peripheral radiating components, positioned around the central radiating component, for transmitting and/or receiving signals of a second RF band. The feed chain also includes a cup, positioned around the plurality of peripheral radiating components, for improving directivity of the transmission and/or reception of the second RF band.

According to some embodiments, the plurality of peripheral radiating components are positioned symmetrically around the central radiating component.

According to some embodiments, the central radiating component has a substantially cylindrical shape. In some embodiments, the central radiating component has a rectangular or square shape. In some embodiments, the central radiating component has a hexagonal shape.

According to some embodiments, the peripheral radiating components each have a substantially cylindrical shape. In some embodiments, the peripheral radiating components each have a rectangular or square shape. In some embodiments, the peripheral radiating components each have a hexagonal shape.

According to some embodiments, the cup has a substantially cylindrical shape.

According to some embodiments, the central radiating component is a horn or a helix and the peripheral radiating components are horns or helices.

According to some embodiments, the central radiating component is configured to transmit in one RF band and receive in another, nonoverlapping RF band. According to some embodiments, the central radiating component is configured to transmit Q band signals and receive Ka and V band signals.

According to some embodiments, the peripheral radiating components are configured to transmit Ka band signals.

According to some embodiments, the feed chain comprises six peripheral radiating components.

According to some embodiments, the feed chain further comprises a second plurality of peripheral radiating components, positioned around the cup, for transmitting and/or receiving signals of the second RF band and a second cup positioned around the second plurality of peripheral radiating components, for improving directivity of the transmission or reception of the second RF band.

According to some embodiments, the cup comprises a splined profile for shaping the directivity of RF signals transmitted or received by the feed chain.

According to some embodiments, the cup comprises a stepped profile for shaping the directivity of RF signals transmitted or received by the feed chain.

According to some embodiments, the central radiating component comprises a splined profile for shaping the directivity of RF signals transmitted or received by the feed chain.

According to some embodiments, the central radiating component comprises a stepped profile for shaping the directivity of RF signals transmitted or received by the feed chain.

According to some embodiments, the peripheral radiating components comprise a stepped profile for shaping the directivity of RF signals transmitted or received by the feed chain.

According to some embodiments, the peripheral radiating components comprise a splined profile for shaping the directivity of RF signals transmitted or received by the feed chain.

According to some embodiments, the peripheral radiating components and the central radiating component are positioned such that free ends of the peripheral radiating components are spaced apart from the free ends of adjacent peripheral radiating components and the central radiating component.

According to some embodiments, the feed chain supports a frequency ratio of at least 1.5.

According to some embodiments, the feed chain is an additively manufactured feed chain.

According to some embodiments, the feed chain is a single integral component.

According to some embodiments, the feed chain is integrated into a steerable antenna system.

According to some embodiments, the peripheral radiating components are combined with a beamforming network.

According to some embodiments, the plurality of peripheral radiating components are arranged in at least two concentric rings around the central radiating component, and the cup is positioned (i) around an inner ring such that not all peripheral radiating components are within the cup or (ii) around an outermost ring such that all peripheral radiating components are within the cup.

According to some embodiments, each ring in the at least two concentric rings is dedicated to transmitting and/or receiving signals in a different, nonoverlapping RF band.

According to some embodiments, the plurality of radiating components is a first plurality of radiating components and the feed chain further comprises a second plurality of radiating components positioned around the first plurality of radiating components, and the second plurality of radiating components are configured to transmit and/or receive signals of at least a third RF band that is different from and non-overlapping with the first and second RF bands.

According to some embodiments, the first plurality of radiating components and the second plurality of radiating components are arranged to form first and second concentric rings around the central radiating component, respectively.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a perspective view of an antenna feed chain, according to an embodiment;

FIG. 2 is a cross sectional perspective view of the antenna feed chain of FIG. 1, according to an embodiment;

FIG. 3 is a perspective view of the antenna feed chain of FIGS. 1 to 2, coupled to RF chain equipment, according to an embodiment;

FIG. 4 is a perspective view of an antenna feed chain, according to another embodiment;

FIG. 5A is a perspective view of an antenna feed chain, according to another embodiment;

FIG. 5B is a cross sectional perspective view of the antenna feed chain of FIG. 5A, according to an embodiment;

FIG. 6A is a cross sectional perspective view of an antenna feed chain, according to another embodiment;

FIG. 6B is a perspective view of the antenna feed chain of FIG. 6A, according to an embodiment;

FIG. 7 is a chart showing a Q band RF pattern of the feed chain of FIGS. 1-3, according to an embodiment;

FIG. 8 is a chart showing a Ka Receive band RF pattern of the feed chain of FIGS. 1-3, according to an embodiment;

FIG. 9 is a chart showing a Ka Transmit band RF pattern of the feed chain of FIGS. 1-3, according to an embodiment; and

FIG. 10 is a chart showing the V band RF pattern of the feed chain of FIGS. 1-3, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to antennas, and more particularly to systems, methods, and devices for wide band antenna feed chains. While the antenna systems described herein are particularly configured for use in space environments, the systems may be applied to any antenna application.

While the present disclosure refers to “horns” (e.g., “central horn”, “peripheral horns”), it is to be understood that a horn or horn antenna represents one possible embodiment of a radiating component or element and that any suitable radiating component may be used. Accordingly, reference to “horn” may be understood to mean radiating component, with a horn and a helix being two example embodiments of the radiating component.

The antenna system components described herein comprise a feed chain configured to transmit and/or receive an ultra-wide range of RF bands. For example, the feed chain may transmit and/or receive an ultra-wide range of RF bands comprising 4 bands (Ka-Tx, Ka-Rx, Q and V), across a frequency range of 17.3 GHZ to 52.4 GHZ in one embodiment. In other embodiments, any number of other frequencies may be supported by the feed chain. In some embodiments, Ku band frequencies, in addition to the frequencies listed above, may be supported by the feed chain described herein.

The feed chain comprises a cylindrical central horn, surrounded by six cylindrical peripheral horns, positioned symmetrically, regularly spaced, around the central horn. The feed chain further comprises a cup, positioned around the peripheral horns, to improve the directivity of the feed chain. In an embodiment, the central horn is configured to transmit Q bands, and receive Ka and V bands and the peripheral horns are configured to transmit Ka band signals. In some embodiments, the central horn may be configured to transmit and/or receive a first band and the peripheral horns may be configured to transmit and/or receive second band. According to some embodiments, the peripheral horns may be configured to transmit and/or receive frequencies lower than those of the central horn to achieve sufficient RF performance.

The feed chain described herein is particularly configured for use with a steerable antenna. Co-locating all RF band components is advantageous in steerable antenna applications, as this co-location may reduce the complexity of the antenna steering process and/or mechanism, improving performance and/or reliability. Further, this co-location may allow a single user and/or gateway to utilize all bands at the same time in one particular location. Such an arrangement may allow the use of a single antenna instead of requiring multiple antennas. In other examples, the feed chain described herein may be applied to non-steerable antenna systems.

The term “feed chain configuration” as used herein refers to the range of possible feed chain specifications when design variables described herein are modified. For example, feed chain configuration may include overall size, number and positions of peripheral horns, RF bands supported by the central horn and peripheral horns, size and shape of peripheral horns and central horn, internal and/or external profile of the cup, central horn and peripheral horns, length or overlap of the cup, feed chain material, and other variables described herein or otherwise.

The term “horn” as used herein refers to a horn antenna, comprising a flaring waveguide, configured to direct radio waves in a beam. The horns described herein may be constructed from metals, other conductive materials, or any other material with may support the transmission of RF signals. Horns may be coupled to other electrical equipment through conduction. Horns may comprise be a smooth wall horn, splined horn, corrugated horn or other types of horns not listed herein with a circular cross section, hexagonal cross section, square cross section, rectangular cross section or other cross sections not listed here.

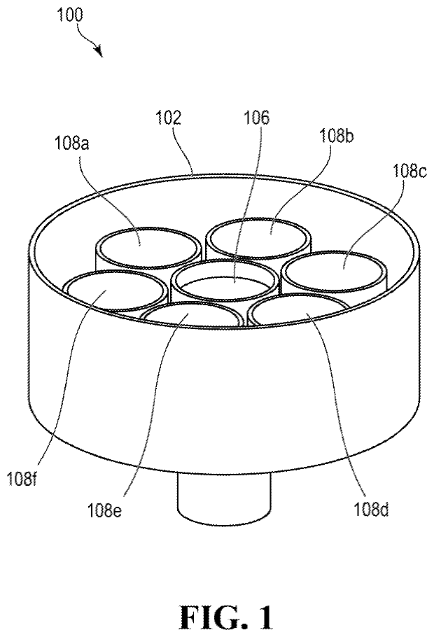

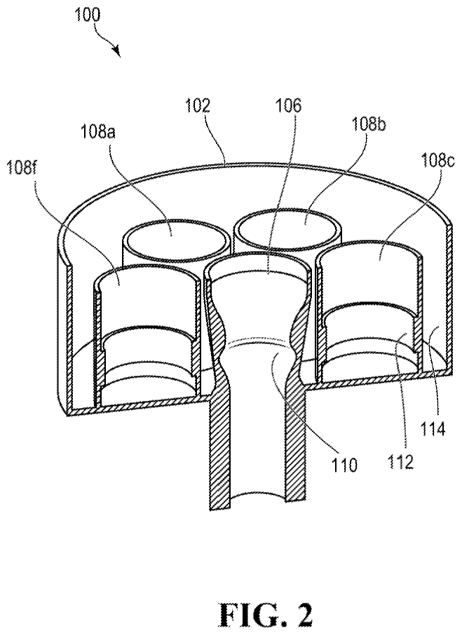

Referring now to FIGS. 1 and 2, pictured therein is a perspective view and perspective cross section view respectively, of an antenna feed chain 100, according to an embodiment. Feed chain 100 comprises a quad-band feed chain, configured to transmit and receive Ka, Q and V band RF signals, spanning a frequency range of 17.3 GHz to 52.4 GHz, for a frequency ratio of 3. In other embodiments, other RF bands and frequency ranges may be supported by the feed chain described herein. In other embodiments, other frequency ratios may apply. For example, the frequency ratio may be higher if the feed chain 100 is configured for operation with lower frequencies (e.g. for some horns such as peripheral horns) than those listed herein. Feed chain 100 comprises cup 102, central horn 106 and peripheral horns 108a-108f. Peripheral horns 108a-108f are referred to collectively as peripheral horns 108 and generically as peripheral horn 108.

In some examples, feed chain 100 may be a single integral component. In such examples, feed chain 100 may be particularly configured to be additively manufactured. In other examples, feed chain 100 may comprise an assembly of several components.

Central horn 106 comprises the RF component configured to transmit and/or receive a first band of RF signals. In the embodiment of FIGS. 1 to 2, central horn 106 is configured to receive Ka-Rx, and V band signals and transmit Q, band signals. Central horn 106 comprises a generally cylindrical RF component, positioned at the center of feed chain 100. The dimensions of central horn 106 may vary based on the configuration of feed chain 100, such as transmission and reception bands, size of peripheral horns 108, number of peripheral horns 108, profile of peripheral horns 108, positioning of peripheral horns 108, size and profile of cup 102 and other system parameters.

As seen in the cross section of FIG. 2, the internal surface 110 of central horn 106 comprises a splined internal profile. This splined internal surface 110 profile may improve the beam shape associated with central horn 106. In other embodiments, other internal surface 110 profiles may be present, depending on feed chain configuration, including without limitation, straight sided, angled, stepped, curved, or any combination thereof.

In some examples, the internal profile of central horn 106 may comprise a corrugated section, such as a corrugated horn. In such examples, corrugations may be vertical or axial.

While central horn 106 is depicted as comprising a cylindrical shape with a circular cross section, in other embodiments, other shape configurations may be applied to central horn 106. For example, hexagonal, rectangular (e.g., square), elliptical, or any other functional shape configuration may be applied to central horn 106. In some embodiments, central horn 106 may comprise a PCB patch element.

Peripheral horns 108 comprise generally cylindrical RF components, configured to receive input RF signals, and transmit them away from feed chain 100, or receive RF signals, and transmit them for further processing through feed chain 100.

Six peripheral horns 108 are present around the perimeter of central horn 106. Each peripheral horn 108 is regularly spaced around central horn 106, providing for symmetry about central horn 106. This symmetrical arrangement promotes RF performance, as a non-symmetrical arrangement may impact the frequency pattern of central horn 106 in some embodiments. Accordingly, while non-symmetrical arrangements may be used, symmetrical arrangements may be preferred.

In the embodiment of FIGS. 1-2, each peripheral horn 108 is spaced slightly apart from the central horn 106, such that the edges of each peripheral horn 108 do not contact the edges of central horn 106, or adjacent peripheral horn 108. Such a spaced arrangement may provide for greater RF performance.

In other embodiments, each peripheral horn 108 may be contacting each adjacent peripheral horn, and/or the central horn 106. In some embodiments, the walls of each peripheral horn 108 and/or the central horn 106 may comprise a single integral component. In such embodiments, adjacent horns may share a common side wall or side edge.

In other embodiments, other numbers of peripheral horns 108 may be present. For example, other embodiments may comprise 3 to 9 peripheral horns 108, positioned around central horn 106. Feed chain 100 requires a minimum of 3 peripheral horns 106 for sufficient RF performance in this embodiment.

In general, a greater amount of spacing between peripheral horns 108 may reduce RF performance of the bands transmitted and/or received by the peripheral horns 108. However, for a fixed number and diameter of peripheral horns 108, a smaller central horn 106 is required to bring the peripheral horns 108 closer together, which may reduce central horn 106 RF performance. Accordingly, in some embodiments an optimal set of parameters may be determined, depending on feed chain configuration and use case requirements, balancing central horn 106 and peripheral horn 108 performance.

In some examples, multiple rows of peripheral horns 108 may be present. For example, in the embodiment of FIGS. 1 to 2, peripheral horns 108 are arranged around central horn 106 in a generally circular pattern. A second concentric circle of peripheral horns 106 may be arranged around the peripheral horns 106 of the embodiment of FIGS. 1 to 2. Such an arrangement may improve the RF performance of the bands associated with peripheral horns 106, depending on the desired band range of the feed chain.

In some examples, a second row of peripheral horns 106 may enable peripheral horns 106 to transmit and/or receive an additional or multiple additional RF bands. For example, the second row of peripheral horns 106 may be configured to transmit signals within a first band (e.g. C band), while the first row of peripheral horns 106 may be configured to transmit signals within a second band (e.g. Ka band). In some examples, the second row may be configured to transmit a band of a frequency lower than the frequency which the first row is configured to transmit. In some examples, first row of peripheral horns 106 and second row of peripheral horns 106 may differ in configuration, for example, diameter or cross-sectional shape, to support different RF bands.

In some examples, a second cup may be present between a first and second row of peripheral horns 106.

In some examples, multiple rows of peripheral horns 106 may be present without any cups or without additional cups.

The signals transmitted or received by each peripheral horn 108 may be combined into a single signal using a beamforming network connected to the peripheral horns 108. This beamforming network may comprise a digital beamforming network, or an analogue beamforming network.

In some embodiments, the internal walls 112 of peripheral horns 108 may comprise a stepped profile, as visible in FIG. 2. Such a profile may provide for greater RF performance by improving the beam shape produced by peripheral horns 108. In other embodiments, internal walls 112 of peripheral horns may comprise a different profile, such as a straight, angled, splined, curved or any other profile, depending on feed chain 100 configuration.

While peripheral horns 108 are depicted as comprising a cylindrical shape with a circular cross section, in other embodiments, other shape configurations may be applied peripheral horns 108, for example, hexagonal, rectangular (e.g., square), elliptical, or any other functional shape configuration may be applied to peripheral horns 108. In some embodiments, each peripheral horn 108 may comprise a PCB patch element.

Cup 102 comprises an RF component surrounding peripheral horns 108. The presence of cup 102 improves the directionality of the peripheral horns 108. In some cases, the cup 102 may improve performance of the peripheral array. In particular, the pattern may be significantly improved (e.g., over embodiments without the cup) having a common launcher in terms of sidelobes and energy on the main lobe. Cup 102 comprises a generally cylindrical structure.

As visible in FIG. 2, The cylindrical walls of cup 102 may extend past the free ends of central horn 106 and peripheral horns 108. This extension beyond the free ends of central horn 106 and peripheral horns 108 improves the RF performance of the band transmitted and/or received by peripheral horns 108.

In some embodiments, the internal walls 114 of cup 102 may comprise a stepped profile, as visible in FIG. 2. Such a profile may provide for greater RF performance by improving the beam shape produced by peripheral horns 108. In other embodiments, internal walls 114 of cup 102 may comprise a different profile, such as a straight, angled, splined, curved or any other profile, depending on feed chain 100 configuration.

The specific geometry of feed chain 100 enables feed chain 100 to advantageously transmit or receive RF signals across a broad frequency range using a single feed chain, while maintaining sufficiently high RF performance across this broad frequency range. Further, this wide band RF transmission and reception is co-located, such that transmission and reception are directed from or to the same point (feed chain 100). This advantageously simplifies and improves antenna steering, in antenna applications wherein antenna steering is required, and wide band transmission and reception is required.

The presence and arrangement of peripheral horns 108 around the central horn 106, as well as the dimensional and geometric ratios and absolute values of feed chain 100 enable this high performance wide band RF transmission and reception.

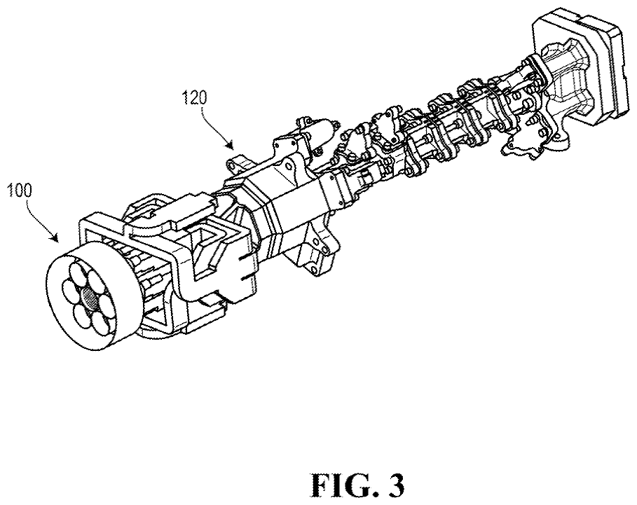

Referring now to FIG. 3, shown therein is a perspective view of feed chain 100, coupled to additional RF chain equipment 120. RF chain equipment 120 includes RF equipment used to supply signals feed chain 100 for RF transmission, and to receive RF signals collected by feed chain 100. RF chain equipment 120 may include components such as septum polarizers, circular polarizers (left hand and right hand configurations), filters, and any other components required for functional RF transmission.

RF chain equipment 120 interfaces with central horn 106 and peripheral horns 108 to transmit and receive RF signals. RF chain equipment 120 may comprise a beamforming network, for application to peripheral horns 108, as described herein. This beamforming network may comprise an analogue beamforming network or digital beamforming network. This beamforming network may comprise multiple beamforming networks.

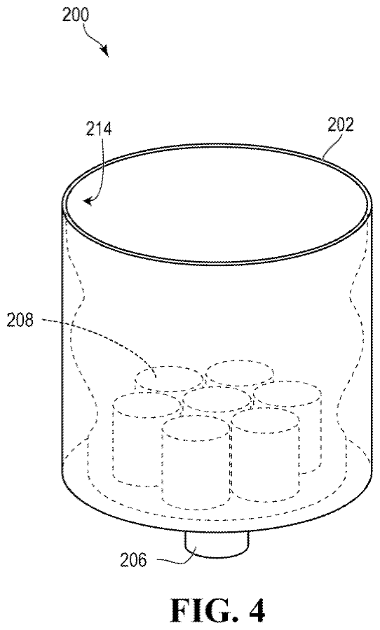

Referring now to FIG. 4, shown therein is a perspective view of feed chain 200, according to an embodiment. Feed chain 200 is analogous to feed chain 100, with reference characters incremented by 100. Description above in reference to feed chain 100 similarly applies to feed chain 200. Feed chain 200 comprises cup 202, peripheral horns 208, and central horn 206.

Feed chain 200 differs from feed chain 100 in that cup 202 comprises a splined profile on internal walls 214. This splined profile allows for the directivity of the RF pattern generated by feed chain 200 to be shaped. Additionally, the cup 202 extends further past the free ends of central horn 206 and peripheral horns 208, than the cup 102 of feed chain 100, further improving directivity of feed chain 200.

Feed chain 200 may provide for improved cross polarization performance for some or all RF bands compared to alternative embodiments, such as feed chain 100.

In other embodiments, other configurations of feed chain 200 or variations of feed chain 200 may be applied.

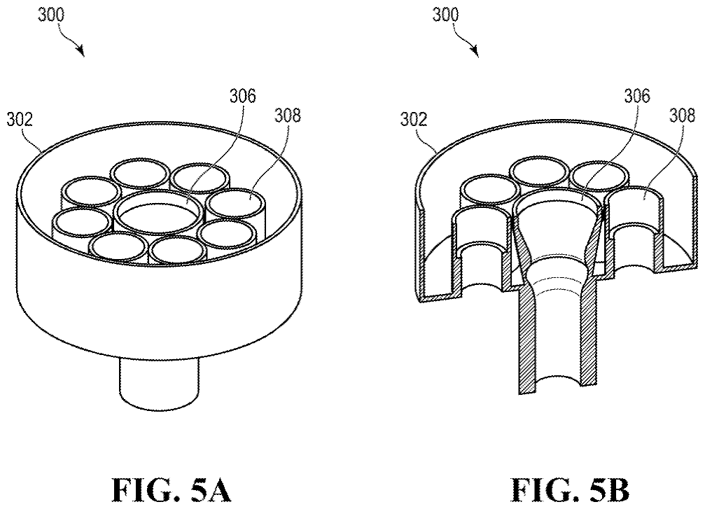

Referring now to FIGS. 5A and 5B, shown therein are perspective and cross sectional perspective views of feed chain 300, respectively, according to an embodiment. Feed chain 300 is analogous to feed chains 100 and 200, with reference characters incremented by 100. Description above in reference to feed chains 100 and 200 similarly applies to feed chain 300. Feed chain 300 comprises cup 302, peripheral horns 308, and central horn 306.

Feed chain 300 differs from feed chains 100 and 200 in that feed chain 300 comprises eight peripheral horns 308 and one central horn 306. Additionally, there is a larger gap between peripheral horns 308 and cup 302 compared to other embodiments.

In other embodiments, other configurations of feed chain 300 or variations of feed chain 300 may be applied.

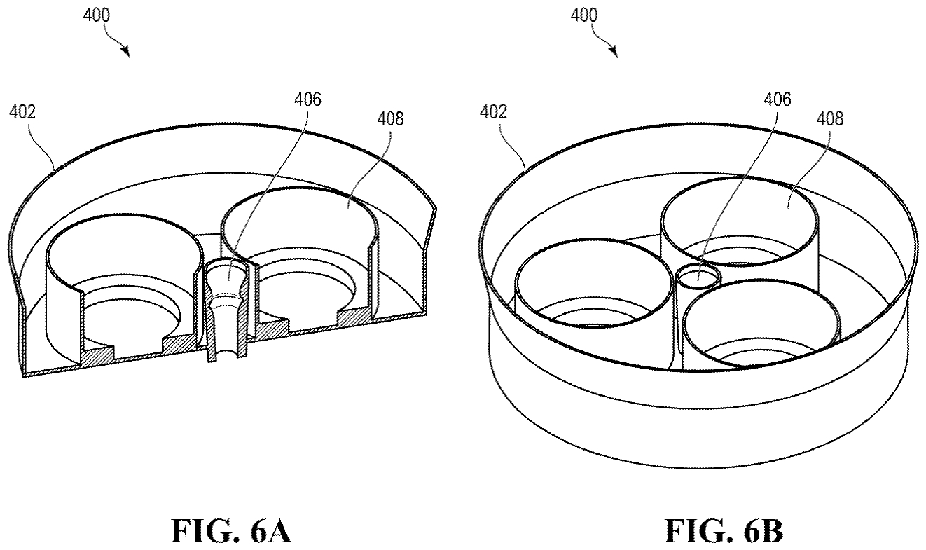

Referring now to FIGS. 6A and 6B, shown therein are cross sectional perspective and perspective views of feed chain 400, respectively, according to an embodiment. Feed chain 400 is analogous to feed chains 100, 200, and 300, with reference characters incremented by 100. Description above in reference to feed chains 100, 200 and 300 similarly applies to feed chain 400. Feed chain 400 comprises cup 402, peripheral horns 408, and central horn 406.

Feed chain 400 differs from feed chains 100, 200 and 300 in that feed chain 400 comprises 3 peripheral horns 408 and one central horn 406. Additionally, peripheral horns 408 are much larger than central horn 406 in contrast to other embodiments.

In other embodiments, other configurations of feed chain 400 or variations of feed chain 400 may be applied.

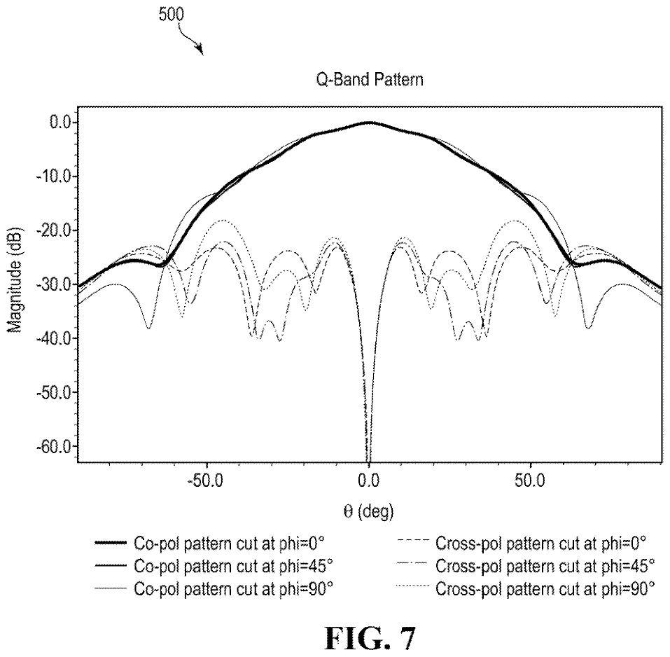

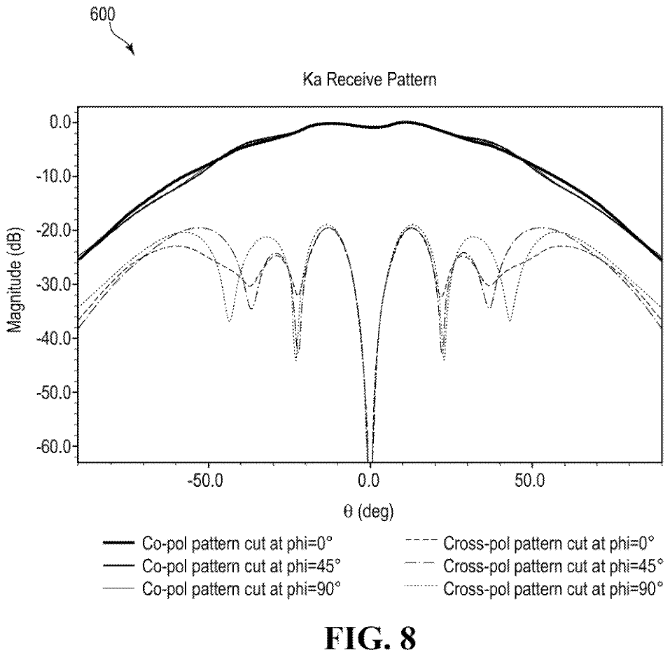

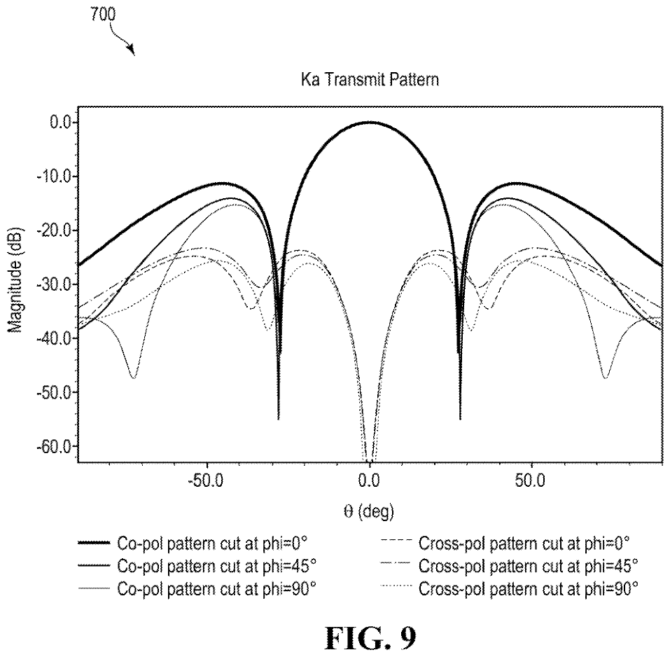

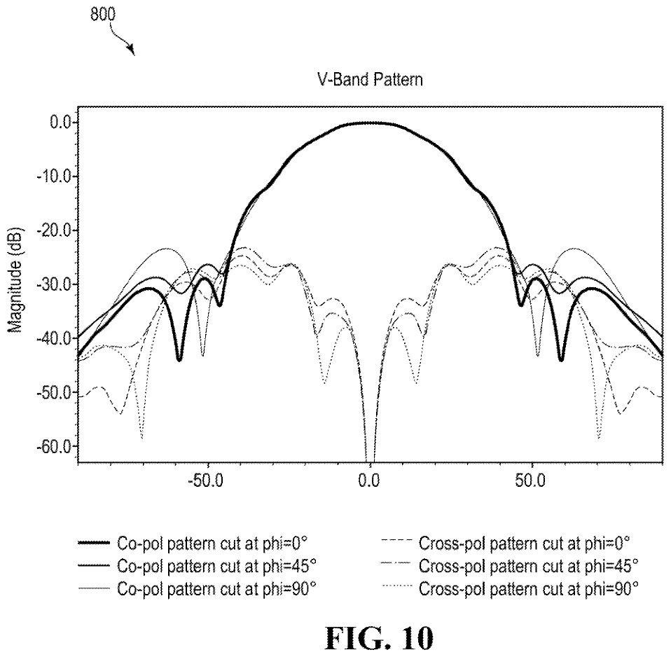

Referring now to FIGS. 7-10, pictured therein are charts 500, 600, 700 and 800, respectively, depicting RF patterns of Q band, Ka Receive band, Ka Transmit band, and V band, respectively, of the feed chain 100 of the embodiment of FIGS. 1-3.

While the above description provides examples of one or more apparatus, methods, or systems, it will be appreciated that other apparatus, methods, or systems may be within the scope of the claims as interpreted by one of skill in the art.

1. An antenna feed chain comprising:
a central radiating component for transmitting or receiving signals of a first RF band;
a plurality of peripheral radiating components, positioned around the central radiating component, for transmitting and/or receiving signals of at least a second RF band, the first and second RF bands being non-overlapping; and
a cup, positioned around the plurality of peripheral radiating components, for improving directivity of the transmission and/or reception of the second RF band.

2. The feed chain of claim 1, wherein at least one of the central radiating component, the peripheral radiating components, and the cup has a substantially cylindrical shape.

3. The feed chain of claim 1, wherein at least two of the central radiating component, the peripheral radiating components, and the cup each have a substantially cylindrical shape.

4. The feed chain of claim 1, wherein the central radiating component, the peripheral radiating components, and the cup each have a substantially cylindrical shape.

5. The feed chain of claim 1, wherein the central radiating component is a horn or a helix and the peripheral radiating components are horns or helices.

6. The feed chain of claim 1, wherein the central radiating component is configured to transmit in one RF band and receive in another nonoverlapping RF band.

7. (canceled)

8. The feed chain of claim 1, wherein the feed chain comprises six peripheral radiating components.

9. The feed chain of claim 1, wherein the feed chain further comprises:
a second plurality of peripheral radiating components, positioned around the cup, for transmitting and/or receiving signals of the second RF band; and
a second cup positioned around the second plurality of peripheral horns, for improving directivity of the transmission or reception of the second RF band.

10. The feed chain of claim 1, wherein the plurality of peripheral radiating components are arranged in at least two concentric rings around the central radiating component, and wherein the cup is positioned (i) around an inner ring such that not all peripheral radiating components are within the cup, or (ii) around an outermost ring such that all peripheral radiating components are within the cup.

11. The feed chain of claim 9, wherein each ring in the at least two concentric rings is dedicated to transmitting and/or receiving signals in a different, nonoverlapping RF band.

12. The feed chain of claim 1, wherein the plurality of radiating components is a first plurality of radiating components and the feed chain further comprises a second plurality of radiating components positioned around the first plurality of radiating components, wherein the second plurality of radiating components are configured to transmit and/or receive signals of at least a third RF band that is different from and non-overlapping with the first and second RF bands.

13. The feed chain of claim 11, wherein the first plurality of radiating components and the second plurality of radiating components are arranged to form first and second concentric rings around the central radiating component, respectively.

14. The feed chain of claim 1, wherein the cup comprises a splined profile for shaping the directivity of RF signals transmitted or received by the feed chain.

15. The feed chain of claim 1, wherein the cup comprises a stepped profile for shaping the directivity of RF signals transmitted or received by the feed chain.

16. The feed chain of claim 1, wherein the central radiating component comprises a splined profile for shaping the directivity of RF signals transmitted or received by the feed chain.

17. The feed chain of claim 1, wherein the central radiating component comprises a stepped profile for shaping the directivity of RF signals transmitted or received by the feed chain.

18. The feed chain of claim 1, wherein the peripheral radiating components comprise a stepped profile for shaping the directivity of RF signals transmitted or received by the feed chain.

19. The feed chain of claim 1, wherein the peripheral radiating components comprise a splined profile for shaping the directivity of RF signals transmitted or received by the feed chain.

20. The feed chain of claim 1, wherein the peripheral radiating components and the central radiating component are positioned such that free ends of the peripheral radiating components are spaced apart from the free ends of adjacent peripheral radiating components and the central radiating component.

21. The feed chain of claim 1, wherein the feed chain supports a frequency ratio of at least 1.5.

22. The feed chain of claim 21, wherein the feed chain is an additively manufactured feed chain.

23. The feed chain of claim 1, wherein the peripheral radiating components are combined with a beamforming network.

24. The feed chain of claim 1, wherein the feed chain is a single integral component.

25. The feed chain of claim 1, wherein the feed chain is integrated into a steerable antenna system.
